(19) United States
(12) Patent Application Publication
(10) Pub. No.: US 2007/0225998 A1
(43) Pub. Date: Sep. 27, 2007

(54) Systems and Methods for Providing, Marketing, and Supporting Integrated Web-Based Software

(76) Inventor: Roger Glenn Howell, Shavertown, PA (US)

Correspondence Address: SUTHERLAND ASBILL & BRENNAN LLP, 999 PEACHTREE STREET, N.E., ATLANTA, GA, 30309, US

(21) Appl. No.: 11/682,056

(22) Filed: Mar. 5, 2007

Related U.S. Application Data
(60) Provisional application No. 60/780,175, filed on Mar. 3, 2006.

(51) Int. Cl. G06Q 10/00; G06Q 30/00

(52) U.S. Cl. 705/1

(57) ABSTRACT

Embodiments of the invention are systems and methods for providing, marketing, and supporting integrated web-based software. In one embodiment, a method of providing an integrated financial and benefits system is provided. The method can include offering to a prospective entity an integrated system comprising a payroll module integrated with a human resources information systems (HRIS) module. Furthermore, the method can include implementing the integrated system for the prospective entity. In addition, the method can include providing consulting services and support to the prospective entity.

### RELATED APPLICATION

This application claims priority to U.S. Provisional Ser. No. 60/780,175, entitled “Systems and Methods for Providing, Marketing, and Supporting Integrated Web-Based Software,” filed Mar. 3, 2006, the contents of which are hereby incorporated by reference.

### FIELD OF THE INVENTION

The invention relates generally to software, and more particularly, to systems and methods for providing, marketing, and supporting integrated payroll and benefits services.

### BACKGROUND OF THE INVENTION

Current administrative processes for payroll, taxes, and human resources have been extremely burdensome and labor-intensive for most companies. In particular, most companies have multiple, independent sources of data and information and multiple administrative systems that operate independently of each other. For example, the accounting or financial services department may have a payroll and tax services system while the human resources department may have its own human resources information system. In this situation, information is not shared between the payroll and tax services system and the human resources information system. Accordingly, an update that is made to one system may not be made to the other system. Moreover, because the updates need to be made multiple times because of multiple systems, there are increases in costs as well as enhanced risks of human error. Furthermore, because of the non-integrated data sets for these separate systems, different departments may provide reports with different answers when presented with the same quantitative question (e.g., How many employees are covered in the benefit plan?).

In addition, the continuous string of new laws and regulations adds an additional layer to complexity and error to the non-integrated administrative systems. For example, laws associated with employee benefits (e.g., HIPAA, ADA, etc.) or compensation (e.g., IRS tax law changes ERISA, COBRA) may change over time. This adds additional operational demands to these non-integrated administrative systems.

When businesses' strategic goals collide with operational demands, a variety of problems can occur. These problems may include anxiety, interruption of work flow, disruption, longer work days, momentum losses, enhanced costs, missed deadlines, rescheduling, delays, excuses, and confusion just to name a few.

Accordingly, there is a need for systems and methods for providing, marketing, and supporting integrated payroll and benefits services.

There is an additional need for integrated financial services and human resources information systems.

### SUMMARY OF THE INVENTION

Embodiments of the invention can address some or all of the above needs. Embodiments of the invention can provide an integrated financial and benefits system operable to be a centralized information source for company management, employees and other persons with a need for information related to payroll associated transactions and/or human resource information associated transactions. Varying levels of consulting, support, and performance guarantees can be implemented with an integrated financial and benefits system to provide suitable customer service to address some or all of the needs of a system user.

In one embodiment of the invention, a method of providing an integrated financial and benefits system can be implemented. The method can include providing an entity with an integrated system comprising a payroll module integrated with a human resources information systems (HRIS) module, wherein the payroll module and the HRIS module share common employee data with each other, wherein the payroll module and the HRIS module each are operable to update the common employee data. The method can also include providing user access to information associated with the payroll module and the HRIS module via a network portal, wherein the information includes at least a portion of the common employee data.

In one aspect of this embodiment, the payroll module and the HRIS module may share common employee data with each other by one of (i) sharing a common database, and (ii) transmitting updates when a change is made to the employee data.

In another aspect of this embodiment, the method can also include transmitting updates to a vendor, wherein the updates are associated with changes to the common employee data.

In yet another aspect of this embodiment, the updates may be transmitted to the vendor in realtime or in a batch transaction.

in yet another aspect of this embodiment, the method can further include updating an operation of the integrated system based upon a consultation with the entity, where the consultation is associated with at least one of: (i) benefits, (ii) cost/budget management, (iii) human resources, (iv) product selection, (v) plan administration, and (vi) employee communications.

In yet another aspect of this embodiment, providing the integrated system can include importing data to the integrated system from a legacy system associated with the entity, where the integrated system automatically determines the common data from the imported data.

In another aspect of this embodiment, the importing data can include automatically resolving conflicts with the determined common data, where the conflicts are resolved using at least one of (i) a prioritization for the determined common data and (ii) updated common data from by the entity.

In another aspect of this embodiment, providing user access can include providing one or more customized reports for the integrated system, where the customized reports include at least a portion of the common data and where the customized reports are accessible from the network portal.

Another embodiment of the invention can include an integrated financial and benefits information system. The system can include a financial services module operable to process payroll associated transactions. In addition, the system can include a human resources services module operable to process human resource information associated transactions, where the financial services module and the human resources services module share common data with each other. Furthermore, the system can include a network portal, wherein the network portal is operable to provide user access via at least one network to information provided by either the financial services module or the human resources services module.

In one aspect of this embodiment, the payroll associated transactions can include at least one of the following: paperless transaction processing, online pay statements, integration with a general ledger, wage and garnishment processing, check register preview, vacation/sick time reporting and calculation, new hire reporting, direct deposit banking, check reconciliation, tax deposits, tax filing, tax credit processing, compliance review, unemployment compensation processing, W-2 processing, online W-2 access, or time and labor management tracking.

In another aspect of this embodiment, the human resource information associated transactions can include at least one of the following: human resources data, government requirements management, annual total compensation for a particular employee, benefits management, government compliance updates, or employee handbook access.

Yet another embodiment of the invention can include a method of providing an integrated financial and benefits system. The method can include integrating at least a portion of functionality associated with a financial services module with at least a portion of functionality associated with a human resource services module, wherein the financial services module is operable to process payroll associated transactions and the human resource services module is operable to process human resource information associated transactions. In addition, the method can include providing user access to functionality associated with the integrated financial services module and human resource services module via a network portal. Furthermore, the method can include receiving a user request for information associated with a transaction performed by functionality associated with the integrated financial services module and human resource services module via a network portal. Furthermore, the method can include based in part on the user request, generating and outputting a report to a user via the network portal.

In an aspect of this embodiment, the method can include transferring data from a legacy-type system to the integrated financial services module and human resource services module. In addition, the method can include based at least in part on the data from the legacy-type system, processing the user request for information.

In another aspect of this embodiment, the method can include receiving a user instruction to format a report. In addition, the method can include based at least in part on the user instruction, formatting the report prior to outputting the report to the user.

In another aspect of this embodiment, payroll associated transactions can include at least one of the following: paperless transaction processing, online pay statements, integration with a general ledger, wage and garnishment processing, check register preview, vacation/sick time reporting and calculation, new hire reporting, direct deposit banking, check reconciliation, tax deposits, tax filing, tax credit processing, compliance review, unemployment compensation processing, W-2 processing, online W-2 access, or time and labor management tracking.

In another aspect of this embodiment, human resource information associated transactions can include at least one of the following: human resources data, government requirements management, annual total compensation for a particular employee, benefits management, government compliance updates, or employee handbook access.

In yet another embodiment of the invention, a method of using an integrated financial and benefits system can be provided. The method can include transmitting a request for information to a network portal. In addition, the method can include receiving information from the network portal, wherein at least a portion of the information is from an integrated financial services module and human resource services module, wherein the financial services module is operable to process payroll associated transactions and the human resource services module is operable to process human resource information associated transactions.

In an aspect of this embodiment, the method can include transmitting authentication-type information to the network portal, wherein authentication of a user's identity is performed prior to processing the request for information.

In another aspect of this embodiment, payroll associated transactions can include at least one of the following: paperless transaction processing, online pay statements, integration with a general ledger, wage and garnishment processing, check register preview, vacation/sick time reporting and calculation, new hire reporting, direct deposit banking, check reconciliation, tax deposits, tax filing, tax credit processing, compliance review, unemployment compensation processing, W-2 processing, online W-2 access, or time and labor management tracking.

In another aspect of this embodiment, human resource information associated transactions can include at least one of the following: human resources data, government requirements management, annual total compensation for a particular employee, benefits management, government compliance updates, or employee handbook access.

Therefore various systems, processes, and apparatus according to various embodiments of the invention can include systems and methods for providing, marketing, and supporting integrated payroll and benefits services.

Other systems and methods according to various embodiments of the invention will become apparent with respect to the remainder of this document.

### BRIEF DESCRIPTION OF THE DRAWINGS

Having thus described the invention in general terms, reference will now be made to the accompanying drawings, which are not necessarily drawn to scale, and wherein:

FIG. 1 is an embodiment of a suite of management and reporting tools according to an illustrative embodiment of the invention.

FIG. 2 illustrates an example method for packaging and marketing the embodiment of FIG. 1.

FIG. 3 illustrates the embodiment of FIG. 1 provided with example consulting and support services according to the example method FIG. 2.

FIGS. 4-12 illustrate example screenshots for an example system in accordance with an embodiment of the invention.

### DETAILED DESCRIPTION OF EMBODIMENTS OF THE INVENTION

Embodiments of the invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

Embodiments of the invention are described below with reference to block diagrams and flowchart illustrations of systems, methods, apparatuses and computer program products. It will be understood that each block of the block diagrams and flowchart illustrations, and combinations of blocks in the block diagrams and flowchart illustrations, respectively, can be implemented by computer program instructions. For example, a block representing a module can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

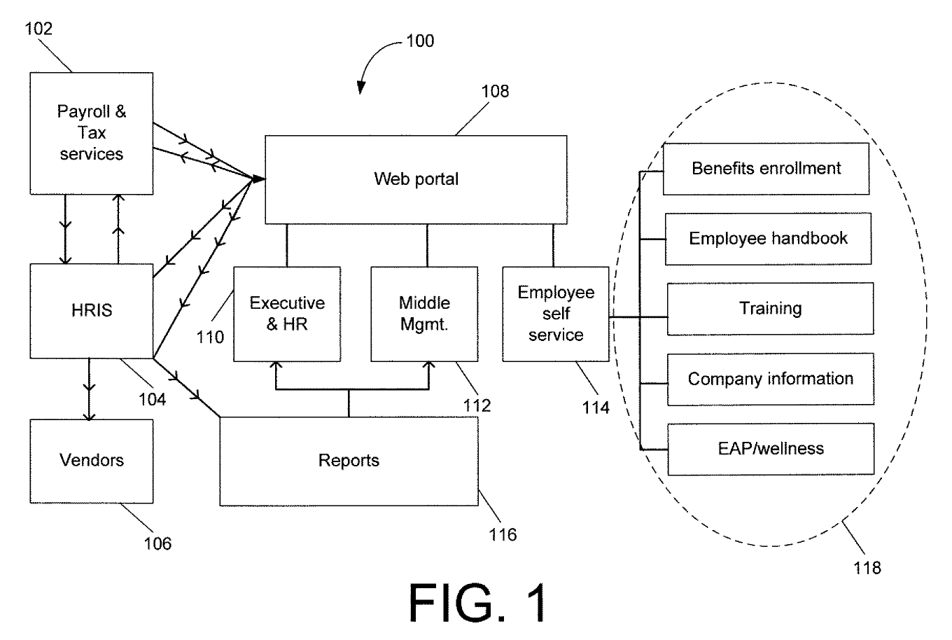

As indicated above, most companies currently have separate administrative systems, including payroll and human resources systems, that operate independently of each other and primarily paper driven benefit enrollment and life event change procedures. By contrast, embodiments of the invention can provide systems and methods for providing, marketing, and supporting integrated payroll and tax and benefits services as may be further illustrated in the accompanying figures, FIGS. 1-12.

FIG. 1 illustrates an embodiment for a suite of management and reporting tools according to an illustrative embodiment of the invention. In particular, an example suite of management and reporting tools can be a set of tools distributed under the brand name WORKPLACE LOGIC™. In the example shown, the system 100 of FIG. 1 can include a payroll and tax services module 102 and a human resources information system (HRIS) module 104. The payroll and tax services module 102 may be Pay eXpert or PC Payroll for Windows, as provided by ADP (Automatic Data Processing), or another suitable payroll and tax services application program provided by another third party. The HRIS module 104 may be Employease's HR Benefits Solutions, ADP's HR eXpert or HR profile, any next generation ADP product, or another suitable human resource information system application program provided by another third party.

According to an embodiment of the invention, the payroll and tax services module 102 and the HRIS module 104 may share common data, or alternatively, exchange or otherwise transmit data between modules or associated databases or data storage devices. To store data for subsequent retrieval and processing, each module 102, 104 can include or can communicate with a respective or integrated database or other type of data storage device. Accordingly, data updates that are made, for example to an employee's benefits selection, will be reflected for both the payroll and tax services module 102 and the HRIS module 104. The payroll and tax services module 102 and HRIS module 104 are illustrated as separate blocks in FIG. 1, but they can be represented as a single integrated module in accordance with an embodiment of the invention.

Each of the payroll and tax services module 102 and the HRIS module 104 may provide a variety of services. In particular, the payroll and tax services module 102 may provide banking, tax, and compensation services. For example, the payroll and tax services module 102 may provide one or more of the following services:
Paperless transaction processing
Online pay statements
Software upgrades can be seamlessly integrated
Multi-level security
Integrated with general ledger
Wage and garnishment processing
Check register preview
Reports online with CD backup
Vacation/sick time reporting and calculation
New hire reporting
Banking services
Direct deposit
Check reconciliation
Tax deposits and filing
Tax credit services
Compliance reviews
Maintain maximum security of sensitive data
Unemployment compensation management
W-2 processing
Online W-2 access
Time and labor management tracking

Other embodiments of a payroll and tax services module can perform some or all of the above functions in addition to other functionality within the scope of the invention.

Similarly, the HRIS module 104 may provide one or more of the following services:
Full-service web-based HRIS integrated with payroll
Accessible business critical information regarding human resources data
Accurately manages government requirements
Ad-hoc reporting capabilities
Annual total compensation of employee
Comprehensive benefits management
Secure business and security integrity
Human resource information and report library
Government compliance updates and reporting
Access to employee handbook

Other embodiments of a HRIS module can perform some or all of the above functions in addition to other functionality within the scope of the invention.

Still referring to FIG. 1, the HRIS module 104, either alone or in conjunction with the payroll and tax services module 102, may provide data to one or more vendors 106, which may include an insurance carrier or benefit vendor. Because the payroll and tax services module 102 communicates and shares data with the HRIS module 104, the vendors 106 can receive consistent data. According to an embodiment of the invention, the payroll and tax services module 102 and the HRIS module 104 may share a database for common data. According to another embodiment of the invention the payroll and tax services module 102 and the HRIS module 104 may maintain separate databases. However, whenever common data is updated by either the payroll and tax services module 102 or the HIRS module 104, updates may be provided to the other module 104 or 102, respectively. These updates may be provided in realtime or in a batch transaction covering updates for a period of time.

Indeed, according to an embodiment of the invention, a vendor 106 (e.g., an insurance carrier, benefit vendor, etc.) may be provided with an updated (and therefore, up-to-date) information such as a telephone number and address for an employee. This updated information may be provided automatically in electronic form, perhaps via network such as the Internet, to the vendor 106 whenever changes are made common data of the payroll module 102 or the HRIS module 104. As described above, the updates may be provided to the vendor 106 in realtime as the changes are made to the common data (e.g., employee data) shared between the payroll module 102 and the HRIS module 104. In another embodiment, the updates may be provided to the vendor 106 in a batch transaction, where the batch transaction reflects changes made over a period of time to the common data.

In accordance with an embodiment of the invention, the payroll and tax services module 102, the HRIS module 104, and a network portal, such as a web portal 108, may be packaged together and marketed to a particular company or entity. The web portal 108 may be ADP's Portal software according to one embodiment of the invention. In another embodiment, other portal-type software provided by another third-party can be used. The web portal 108 enables employees to access a variety of information from the payroll and tax services module 102 and the HRIS module 104 over a network such as the Internet. For example, in embodiments of the invention, three classes of employees may be allowed to access the web portal 108, which may be a single point of access with built-in security features. These built-in security features may require the use of a username and/or password or other identifier. These classes of employees that may utilize the web portal 108 may include executives and HR 110, middle management 112, and employees 114 according to one embodiment. One of ordinary skill in the art will recognize that may other variations in classifications of employees or other users may utilize the web portal 108 in accordance with an embodiment of the invention.

From the web portal 108, executives and HR 110 may access a variety of services. For example, the executives and HR 110 may be provided with accurate, real-time information reports, such as 116, to enhance strategic decision making in one or more areas of payroll, labor, staffing, and benefit budgets and expenses. Likewise, the web portal 108 may also provide one or more of the following services:
Secure access to employee and payroll information
Access to CCH's searchable database and research exchange for regulation and compliance requirements
Reports, such as tax liability reports for local, state, and federal taxes
Real-time compliance updates
Government compliance reviews and reports
Premium reconciliations

Other embodiments of a network portal or web portal can perform some or all of the above functions in addition to other functionality within the scope of the invention.

Similarly, middle management 112 may also be able to access the web portal 108 and obtain a variety of services. These services may include:
Human resource and cost reports for monitoring and controlling
Powers management to track and view information about departments and direct reports (e.g., vacation and sick time tracking, departmental time and labor
Tracking salary adjustments and employment history of subordinates (e.g. promotions, performance reviews)

Other embodiments of a network portal or web portal can perform some or all of the above functions in addition to other functionality within the scope of the invention.

The reports 116 generated via the web portal 108 for either the executives and HR 110 or the middle management 112 may be standard reports, ad hoc reports, or customized reports. Ad hoc reports may be provided via ADP's (Automatic Data Processing) Ad Hoc Report Writer. Customized reports may also be preprogrammed and archived for easy access by the executives and HR 110 or the middle management 112.

In addition, other employees 114 may be able to obtain self service information 118 via the network portal, such as web portal 108. In particular, this self service information 118 may include one or more of benefit enrollment information, employee handbooks, training manuals and information, company information (e.g., policies, forms, etc.), and information regarding employee assistance programs (EAP) and wellness programs.

In this manner, an integrated financial and benefits system, such as system 100, can provide a centralized information source for company management, employees, and other persons with a need for information related to payroll associated transactions and/or human resource information associated transactions.

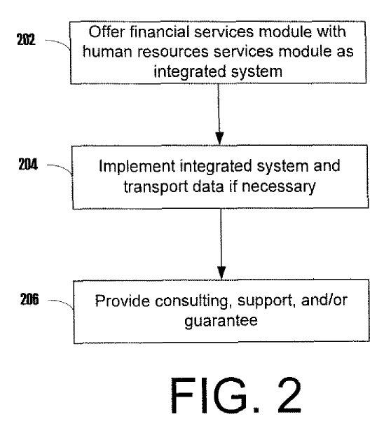

Having described the system 100 in FIG. 1 above, a process 200 for packaging and marketing the system 100 by a benefit services provider or other entity to prospective companies or entities will now be described with reference to the flow diagram of FIG. 2. In an embodiment of the invention, prospective companies or entities may have between approximately 2 to 10,000 employees. In other embodiments, prospective companies or entities can have a greater number of employees. In particular, in block 202 of process 200 shown in FIG. 2, a benefit services provider can offer the prospective company or entity access to a financial services module (e.g., a payroll and tax services module 102) that is integrated with the human resources services module (e.g., HRIS module 104) as an integrated system. According to an embodiment of the invention, the employees of the company or entity would be able to access the integrated financial services module and the human resources services module (and the associated data) via a network portal (e.g., web portal 108). In another embodiment of the invention, the web portal 108 would be accessible via a network such as the Internet. However, one of ordinary skill in the art will recognize that a network portal, such as web portal 208, could also be accessible over one or more private, local area, wide area networks, or other types of networks as well.

In block 204, upon selection by the company or entity, the integrated system described above is implemented for the company. In particular, data from a legacy system (e.g., separate payroll systems and HR systems) can be ported over to the previously installed integrated system. According to an embodiment of the invention, the integrated system may determine, perhaps automatically, common data (e.g., across the separate payroll and HR systems) for the payroll and tax services module 102 and the HRIS module 104, as well as other modules. Indeed, common data may be determined from a listing of known types of common employee information (address, telephone number, etc.), according to an embodiment of the invention. It will be appreciated that conflicts in the common data (e.g., conflicting data imported from disparate sources) may be resolved by the integrated system using one or more methods. In an embodiment, the company or entity may provide a listing of updated information for automatically resolving these conflicts. According to another embodiment of the invention, the conflicts may be resolved manually or according to a priority (e.g., selecting the information with the most recent date). Once common data has been determined, it may be stored in a single shared database, as described above. If individual modules maintain separate databases for common data, then updates may be utilized to harmonize common information between or among modules. Further, the benefits services provider may program customized reports according to the needs of the company or entity (e.g., for executives, HR, other employees, etc.). Indeed, these customized reports may be stored as templates and utilized by employees of the company or entity as necessary.

In block 206, before, during, and subsequent to the implementation process of block 204, the benefits services provider may provide the company or entity with one or more of consulting services, support, and a performance guarantee. In particular, the consulting services may include assisting the company or entity with cost/budget management, benefits consulting, employee communications, plan administration, other product selection, and HR consulting. Likewise, the ongoing support may include on-site support, web-based training, phone support, field support, electronic support (e.g., email), web portal updates, and implementation training. Finally, there may be a guarantee that the integrated system performs as promised in block 202.

The process 200 of FIG. 2 ends at block 206.

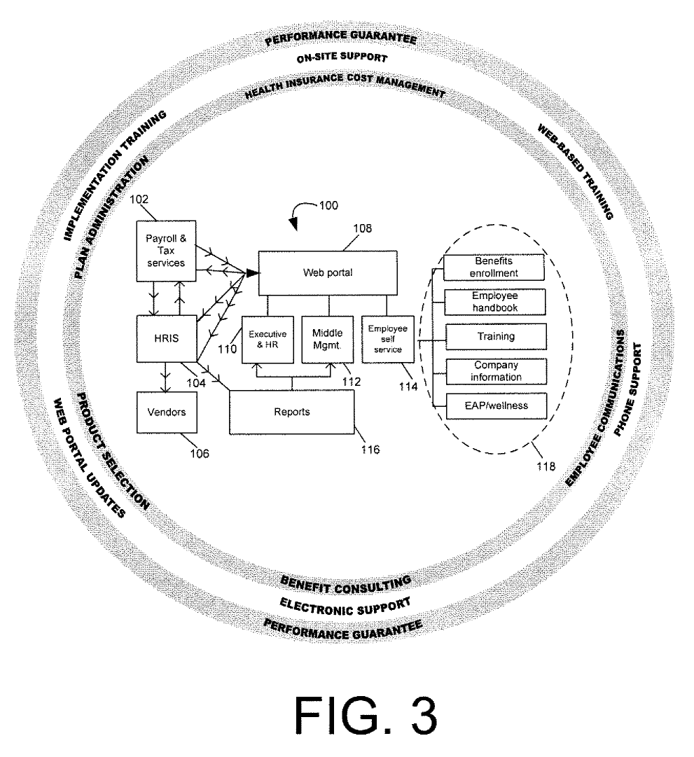

FIG. 3 illustrates an example system 100 as implemented by one or more of consulting 250, support 252, and a performance guarantee 254. One of ordinary skill in the art will recognize that other embodiments of the invention may have some, all, or varying portions of the consulting 250, support 252, and performance guarantee 254 described above.

Consulting 250 can be a service provided by a company, entity, or person to provide additional expertise, instruction, or advice to a user of the system 100. For example, one or more consultants can address various issues, questions, or concerns raised by company management, such as executives and HR 110 or middle management 112. These consultants can address some or all of the following: benefits consulting, cost and budget management, human resources consulting, product selection, benefits plan administration, or employee communications. Other similar types of functions can be addressed by consulting implemented with the system in accordance with an embodiment of the invention.

Support 252 can be a service provided by a company, entity, or person to provide additional expertise, instruction, or advice to a user of the system 100 before, during, or after implementation of the system 100. For example, one or more technical support personnel can address various issues, questions, or concerns raised by company management, such as executives and HR 110, middle management 112, or employees 114. These technical support personnel can address some or call of the following: on-site support, web-based training, phone support, electronic support, network or web portal updates, and implementation training. Other similar types of functions can be addressed by support implemented with the system in accordance with an embodiment of the invention.

A performance guarantee 254 can be a service or warranty provided by a company, entity, or person to define a minimum level of functionality or service provided by the system 100, consulting 250 and/or support 252. For example, a suitable performance guarantee can be warranty under which a providing company or entity agrees that an integrated system, such as 100, will be continuously accessible to a company, and its management and employees for a prefixed period of time, such as one year. In the event, the company, management, or employee is dissatisfied with a particular service or function provided by the system 100, consulting 250 and/or support 252, the providing company or entity can agree to provide appropriate services to attempt to resolve the dissatisfaction. Other similar types of functions can be addressed by a performance guarantee implemented with the system in accordance with an embodiment of the invention.

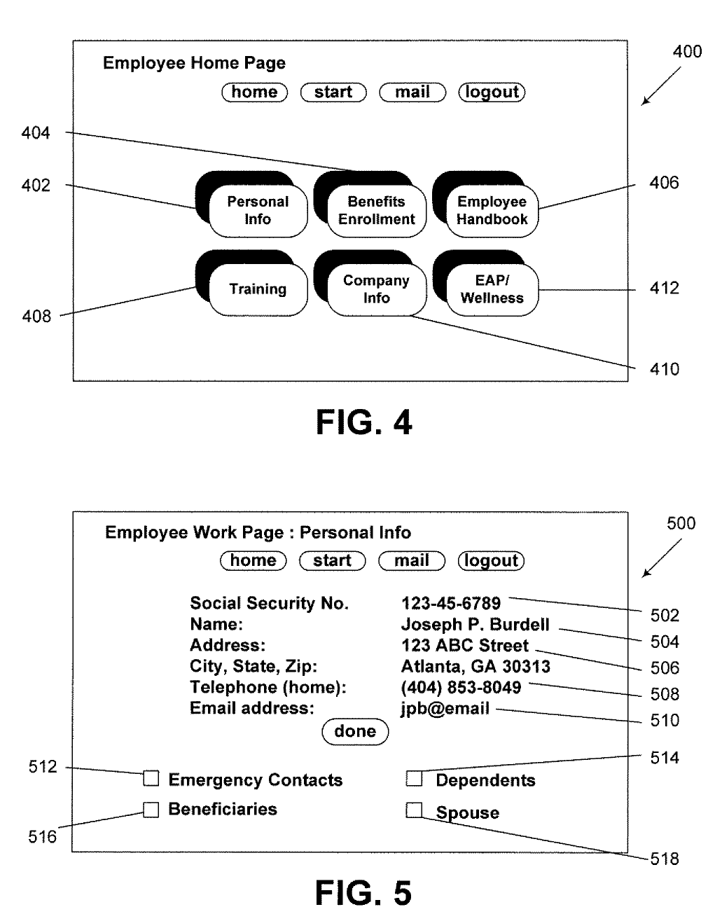

FIGS. 4-12 illustrate example screenshots for an example system in accordance with an embodiment of the invention. The screenshots 400, 500, 600, 700, 800, 900, 1000, 1100, 1200 are shown by way of example only, and illustrate an embodiment of the invention. In the embodiment shown, the screenshots can be displayed via a network portal or web portal 108 in FIG. 1, on an output device, such as a display device, for a user to view. Other arrangements and configurations can be utilized for other screenshots in accordance with other embodiments of the invention.

FIGS. 4-8 illustrate example screenshots for an employee, such as 114, to interact with a system, such as 100. In FIG. 4, the screenshot 400 illustrates a home page for a user, such as an employee 114, to interact with a system, such as 100 in FIG. 1. The user or employee 114 can utilize an input device, such as a mouse or other similar device, to input a command or otherwise select a predefined function by clicking the mouse on one of the screen buttons, such as 402. The screen buttons can each correspond to a predefined function associated with an integrated payroll and tax services module, such as 102, and HRIS module, such as 104. Various functions associated with an integrated payroll and tax services module, such as 102, and HRIS module, such as 104, are previously described above. In the example shown, a screen button 402 can include functionality related to personal information. Other screen buttons 404, 406, 408, 410, 412 can include functionality associated with benefits enrollment, employee handbook, training, company information, and EAP/wellness. In other embodiments of the invention, screen buttons can include, but are not limited to, functionality related to directory information, work, previously input requests, and events.

In FIG. 5, the screenshot 500 illustrates a web page for a user, such as an employee 114, to interact with a system such as 100 in FIG. 1. The user or employee 114 can obtain and review various information previously stored by an integrated payroll and tax services module, such as 102, and HRIS module, such as 104. In the example shown, personal-type information can be called upon by a user, and displayed on an Output device for the user to review. In this example, the user 114 can add, delete, or edit information displayed in corresponding fields on the screen, such as a social security number 502, name 504, address 506, telephone number 508, or e-mail address 510. Screen buttons 512, 514, 516, 518 can permit a user to review, select, and edit additional information such as emergency contacts, dependents, beneficiaries, and spouse information. In other embodiments of the invention, other fields or screen buttons can include, but are not limited to, type of familial relationship, home and work phone numbers, facsimile numbers, pager numbers, mobile telephone numbers, type of beneficiary, and beneficiary benefits percentages.

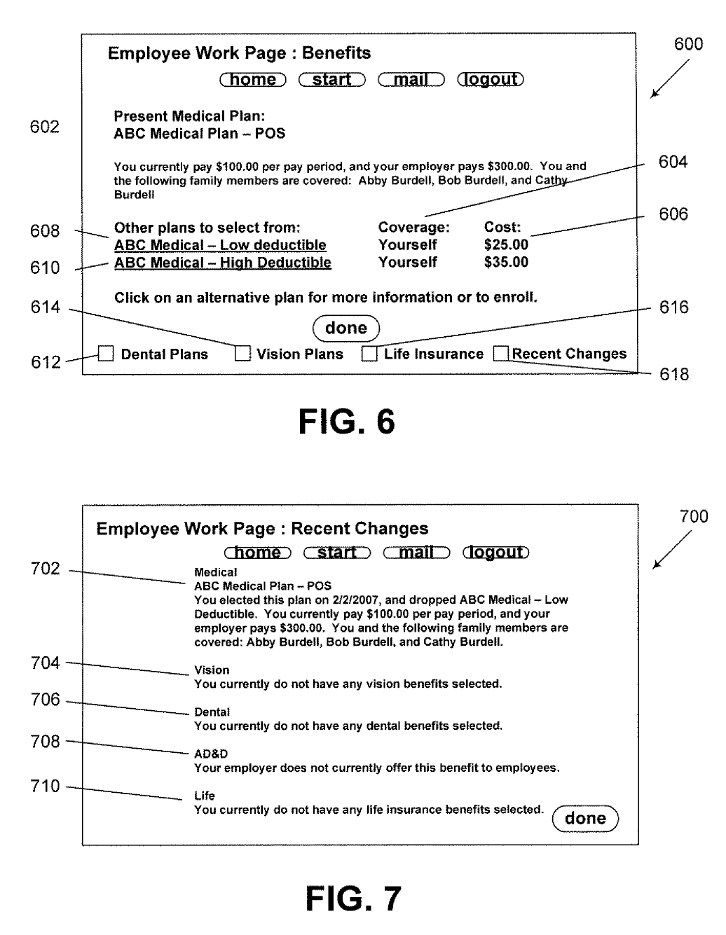

In FIG. 6, the screenshot 600 illustrates a web page for a user, such as an employee 114, to interact with a system such as 100 in FIG. 1. The user or employee 114 can obtain and review various benefits information previously stored by an integrated payroll and tax services module, such as 102, and HRIS module, such as 104. In the example shown, benefits-type information can be called upon by a user, and displayed on an output device for the user to review. In this example, the user 114 can review information displayed in corresponding fields on the screen, such as a particular medical plan 602, type of coverage 604, and cost 606. Links 608, 610 to alternative medical plans can be displayed for user selection. Screen buttons 612, 614, 616, 618 can permit a user to review, select, and edit additional information such as dental plans, vision plans, life insurance, and recent changes. In other embodiments of the invention, other fields or screen buttons can include, but are not limited to, types of plans a user may qualify for, list of family members covered under a particular plan, and a selection of family members to be covered under a proposed plan.

In FIG. 7, the screenshot 700 illustrates a web page for a user, such as an employee 114, to interact with a system such as 100 in FIG. 1. The user or employee 114 can obtain and review various benefits information previously stored by an integrated payroll and tax services module, such as 102, and HRIS module, such as 104. In the example shown, benefits-type information can be called upon by a user, and displayed on an output device for the user to review. In this example, the user 114 can review information displayed in corresponding fields on the screen, such as a particular medical plan 702, vision plan 704, dental plan 706, accidental death and dismemberment plan 708, and life insurance 710. Screen buttons, similar to those previously described above, can permit a user to review, select, and edit additional information regarding alternative medical plans, dental plans, vision plans, accidental death and dismemberment plans, life insurance, a summary of a plan description, comparative type information, pending changes, review of a change in benefits, and recent changes. In other embodiments of the invention, other fields can include, but are not limited to, a brief description of the type and scope of benefit coverage, specific payments by an employee and employer for a particular benefit, date of a change request, and an enrollment date.

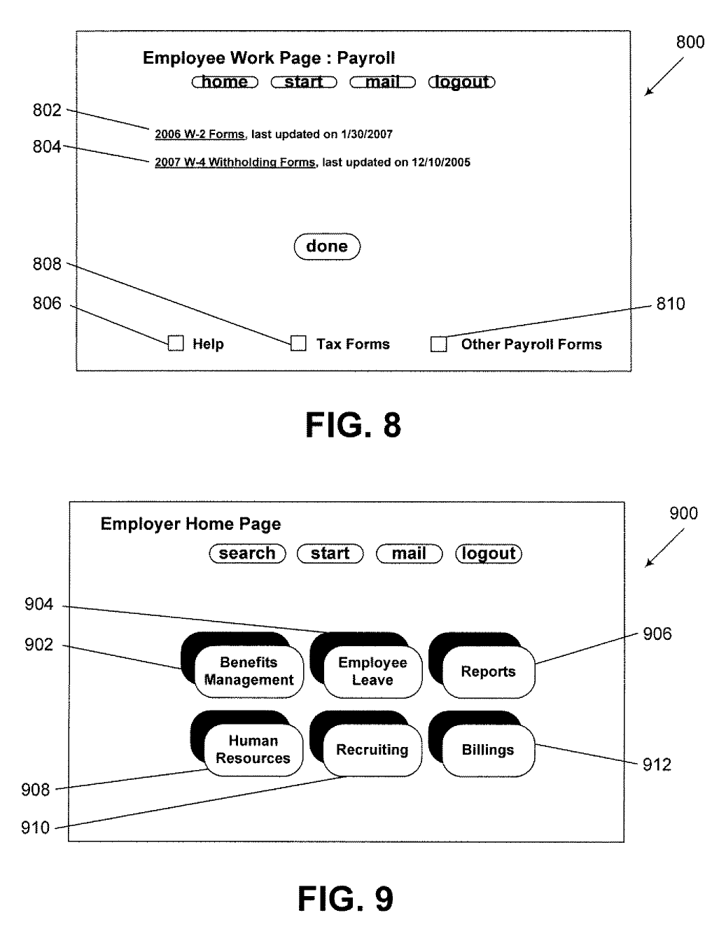

In FIG. 8, the screenshot 800 illustrates a web page for a user, such as an employee 114, to interact with a system such as 100 in FIG. 1. The user or employee 114 can obtain and review various benefits and tax information previously stored by an integrated payroll and tax services module, such as 102, and HRIS module, such as 104. In the example shown, tax-type information can be called upon by a user, and displayed on an output device for the user to review. In this example, the user 114 can review information displayed in corresponding fields on the screen, such as a W-2 form 802, and a W-4 withholding form 804. Screen buttons 806, 808, 810 can permit a user to review, select, and edit additional information regarding tax forms, other payroll forms, and help. In other embodiments of the invention, other fields can include, but are not limited to, W-5 forms, Internal Revenue Service (IRS) or another tax authority's forms.

In FIG. 9, the screenshot 900 illustrates a home page for a user, such as executives and HR shown as 110 in FIG. 1, or middle management 112, to interact with a system, such as 100 in FIG. 1. The user, such as 110 or 112 can utilize an input device, such as a mouse or other similar device, to input a command or otherwise select a predefined function by clicking the mouse on one of the screen buttons, such as 902. The screen buttons can each correspond to a predefined function associated with an integrated payroll and tax services module, such as 102, and HRIS module, such as 104. Various functions associated with an integrated payroll and tax services module, such as 102, and HRIS module, such as 104, are previously described above. In the example shown, a screen button 902 can include functionality related to benefits management. Other screen buttons 904, 906, 908, 910, 912 can include functionality associated with employee leave, reports, human resources, recruiting, and billings. In other embodiments of the invention, screen buttons can include, but are not limited to, functionality related to company, and employees.

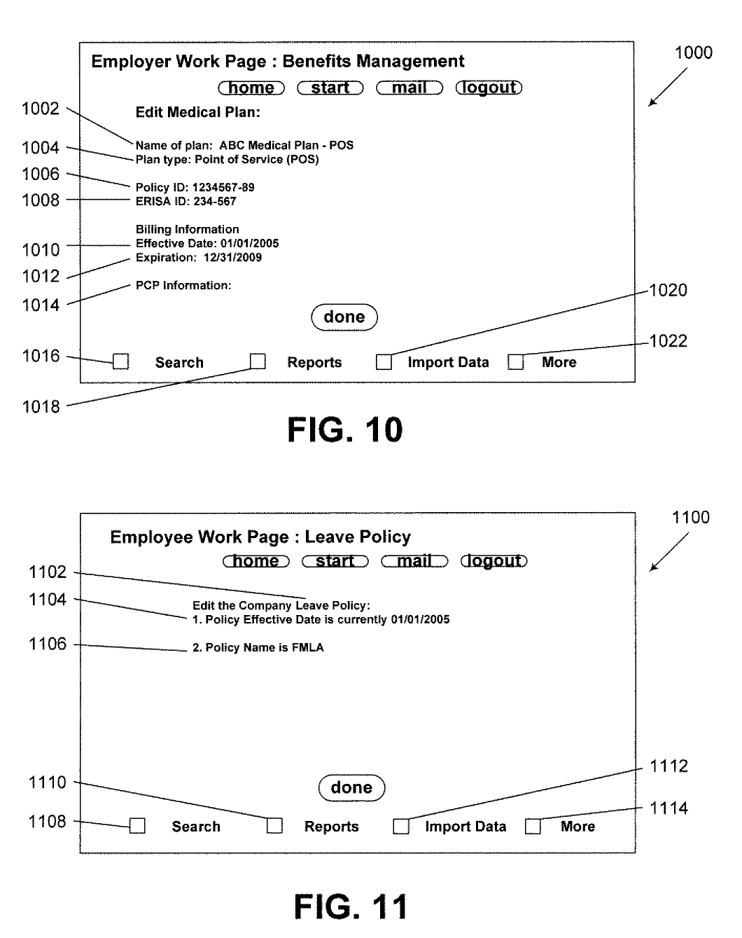

In FIG. 10, the screenshot 1000 illustrates a web page for a user, such as 112 or 114 to interact with a system such as 100 in FIG. 1. The user 112 or 114 can obtain and review various information previously stored by an integrated payroll and tax services module, such as 102, and HRIS module, such as 104. In one example, a user 112, 114 can call on specific benefit management-type information for a specific employee. In the example shown, benefits management-type information can be called upon by a user, and displayed on an output device for the user to review. In this example, the user 112, 114 can add, delete, or edit information displayed in corresponding fields on the screen, such as a name of a medical plan 1002, plan type 1004, policy identification 1006, ERISA identification 1008, billing information such as effective date 1010 and expiration date 1012, and PCP information 1014. In other embodiments of the invention, other fields can include, but are not limited to, provider, HIPAA type, whether an employee qualifies for COBRA, a broker name, plan anniversary, billing cut-off, and retroactive term limit. The screen buttons 1016, 1018, 1020, 1022 shown can each correspond to a predefined function associated with an integrated payroll and tax services module, such as 102, and HRIS module, such as 104. Various functions associated with an integrated payroll and tax services module, such as 102, and HRIS module, such as 104, are previously described above. In the example shown, a screen button 1016 can include functionality related to searching for other policies. Other screen buttons 1018, 1020, and 1022 can include functionality associated with reports, import data, and more functions.

In FIG. 11, the screenshot 1100 illustrates a web page for a user, such as 112 or 114 to interact with a system such as 100 in FIG. 1. The user 112 or 114 can obtain and review various information previously stored by an integrated payroll and tax services module, such as 102, and HRIS module, such as 104. In one example, a user 112, 114 can call on specific policy management-type information. In the example shown, policy management-type information can be called upon by a user, and displayed on an output device for the user to review. In this example, the user 112, 114 can add, delete, or edit information displayed in corresponding fields on the screen, such as a name of a policy 1102, and effective date 1104. In other embodiments of the invention, other fields can include, but are not limited to, original start date, whether an employee is paid or unpaid during a policy term, whether some or all employees are affected by a particular policy, and time tracking for employees during a particular policy. The screen buttons can each correspond to a predefined function associated with an integrated payroll and tax services module, such as 102, and HRIS module, such as 104. Various functions associated with an integrated payroll and tax services module, such as 102, and HRIS module, such as 104, are previously described above. In the example shown, a screen button 1106 can include functionality related to searching for other policies. Other screen buttons 1108, 1110, and 1112 can include functionality associated with reports, import data, and more functions.

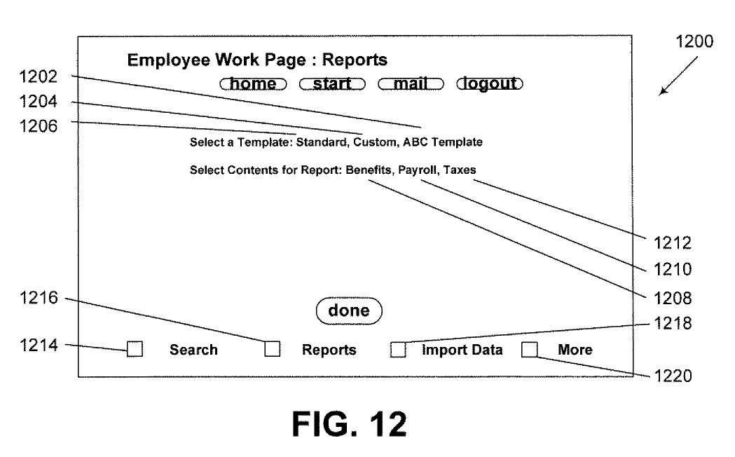

In FIG. 12, the screenshot 1200 illustrates a web page for a user, such as 112 or 114 to interact with a system such as 100 in FIG. 1. The user 112 or 114 can obtain and review various information previously stored by an integrated payroll and tax services module, such as 102, and HRIS module, such as 104. In the example shown, report-type information can be called upon by a user, and displayed on an output device for the user to review. In this example, the user 112, 114 can add, delete, or edit information displayed in corresponding fields on the screen, such as a template for a report 1202, 1204, 1206, and contents for a report 1208, 1210, 1212. In other embodiments of the invention, other fields can include, but are not limited to, various fields for a report. The screen buttons can each correspond to a predefined function associated with an integrated payroll and tax services module, such as 102, and HRIS module, such as 104. Various functions associated with an integrated payroll and tax services module, such as 102, and HRIS module, such as 104, are previously described above. In the example shown, a screen button 1214 can include functionality related to searching for other policies. Other screen buttons 1216, 1218, and 1220 can include functionality associated with reports, import data, and more functions.

One skilled in the art will recognize that a system such as an integrated payroll and tax services module, such as 102, and HRIS module, such as 104, can utilize various configurations of data input and output screens, including some or all of the screens shown in FIGS. 4-12, in accordance with an embodiment of the invention.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

The claimed invention is:

1. A method of providing an integrated financial and benefits system, comprising:
providing an entity with an integrated system comprising a payroll module integrated with a human resources information systems (HRIS) module, wherein the payroll module and the HRIS module share common employee data with each other, wherein the payroll module and the HRIS module each are operable to update the common employee data; and
providing user access to information associated with the payroll module and the HRIS module via a network portal, wherein the information includes at least a portion of the common employee data.

2. The method of claim 1, wherein the payroll module and the HRIS module share common employee data with each other by one of (i) sharing a common database, and (ii) transmitting updates when a change is made to the common employee data.

3. The method of claim 1, further comprising transmitting updates to a vendor, wherein the updates are associated with changes to the common employee data.

4. The method of claim 1, wherein the updates are transmitted to the vendor in realtime or in a batch transaction.

5. The method of claim 1, further comprising updating an operation of the integrated system based upon a consultation with the entity, wherein the consultation is associated with at least one of: (i) benefits, (ii) cost/budget management, (iii) human resources, (iv) product selection, (v) plan administration, and (vi) employee communications.

6. The method of claim 1, wherein providing the integrated system comprises importing data to the integrated system from a legacy system associated with the entity, wherein the integrated system automatically determines the common data from the imported data.

7. The method of claim 6, wherein importing data includes automatically resolving conflicts with the determined common data, wherein the conflicts are resolved using at least one of (i) a prioritization for the determined common data and (ii) updated common data from by the entity.

8. The method of claim 1, wherein providing user access includes providing one or more customized reports for the integrated system, wherein the customized reports include at least a portion of the common data and wherein the customized reports are accessible from the network portal.

9. An integrated financial and benefits information system, comprising:
a financial services module operable to process payroll associated transactions;
a human resources services module operable to process human resource information associated transactions wherein the financial services module and the human resources services module share common data with each other; and
a network portal, wherein the network portal is operable to provide user access via at least one network to information provided by either the financial services module or the human resources services module.

10. The system of claim 9, wherein payroll associated transactions comprise at least one of the following: paperless transaction processing, online pay statements, integration with a general ledger, wage and garnishment processing, check register preview, vacation/sick time reporting and calculation, new hire reporting, direct deposit banking, check reconciliation, tax deposits, tax filing, tax credit processing, compliance review, unemployment compensation processing, W-2 processing, online W-2 access, or time and labor management tracking.

11. The system of claim 9, wherein human resource information associated transactions comprise at least one of the following: human resources data, government requirements management, annual total compensation for a particular employee, benefits management, government compliance updates, or employee handbook access.

12. A method of providing an integrated financial and benefits system, comprising:
integrating at least a portion of functionality associated with a financial services module with at least a portion of functionality associated with a human resource services module, wherein the financial services module is operable to process payroll associated transactions and the human resource services module is operable to process human resource information associated transactions;
providing user access to functionality associated with the integrated financial services module and human resource services module via a network portal;
receiving a user request for information associated with a transaction performed by functionality associated with the integrated financial services module and human resource services module via a network portal; and
based at least in part on the user request, generating and outputting a report to a user via the network portal.

13. The method of claim 12, further comprising:
transferring data from a legacy-type system to the integrated financial services module and human resource services module; and
based at least in part on the data from the legacy-type system, processing the user request for information.

14. The method of claim 12, further comprising:
receiving a user instruction to format a report; and
based at least in part on the user instruction, formatting the report prior to outputting the report to the user.

15. The method of claim 12, wherein payroll associated transactions comprise at least one of the following: paperless transaction processing, online pay statements, integration with a general ledger, wage and garnishment processing, check register preview, vacation/sick time reporting and calculation, new hire reporting, direct deposit banking, check reconciliation, tax deposits, tax filing, tax credit processing, compliance review, unemployment compensation processing, W-2 processing, online W-2 access, or time and labor management tracking.

16. The method of claim 12, wherein human resource information associated transactions comprise at least one of the following: human resources data, government requirements management, annual total compensation for a particular employee, benefits management, government compliance updates, or employee handbook access.

17. A method of using an integrated financial and benefits system, comprising:
transmitting a request for information to a network portal,
receiving information from the network portal, wherein at least a portion of the information is from an integrated financial services module and human resource services module, wherein the financial services module is operable to process payroll associated transactions and the human resource services module is operable to process human resource information associated transactions.

18. The method of claim 17, further comprising:
transmitting authentication-type information to the network portal, wherein authentication of a user's identity is performed prior to processing the request for information.

19. The method of claim 17, wherein payroll associated transactions comprise at least one of the following: paperless transaction processing, online pay statements, integration with a general ledger, wage and garnishment processing, check register preview, vacation/sick time reporting and calculation, new hire reporting, direct deposit banking, check reconciliation, tax deposits, tax filing, tax credit processing, compliance review, unemployment compensation processing, W-2 processing, online W-2 access, or time and labor management tracking.

20. The method of claim 17, wherein human resource information associated transactions comprise at least one of the following: human resources data, government requirements management, annual total compensation for a particular employee, benefits management, government compliance updates, or employee handbook access.
